(19) United States
(12) Patent Application Publication
(10) Pub. No.: US 2014/0244422 A1
(43) Pub. Date: Aug. 28, 2014

(54) Providing Information about Print Service Providers to Print Product

(71) Applicant: HEWLETT-PACKARD DEVELOPMENT COMPANY, LP., (US)

(72) Inventors: Fabio Giannetti, Palo Alto, CA (US); John Ludd Recker, Palo Alto, CA (US); Gary J. Dispoto, Palo Alto, CA (US)

(73) Assignee: HEWLETT-PACKARD DEVELOPMENT COMPANY, L.P., Houston, TX (US)

(21) Appl. No.: 13/776,019

(22) Filed: Feb. 25, 2013

(51) Int. Cl. G06Q 30/06

(52) U.S. Cl. CPC G06Q 30/0621
USPC 705/26.5

(57) ABSTRACT

Examples disclosed herein relate to providing information about print service providers to create a print product. In one implementation, a processor matches a subset of the print service providers with a user query for a service to produce a custom print product. The processor may determine a manner of displaying information about the matched print service providers based on criteria related to the desirability of producing the custom print product associated with at least one of the print service providers. The processor may cause the information to be displayed in the determined manner

### BACKGROUND

Print service providers may provide custom print products to users. A user may have design a custom image and select custom specifications for the product. For example, the specifications may indicate to print the image with a particular paper size, weight, and luster or with a particular binding style.

### BRIEF DESCRIPTION OF THE DRAWINGS

The drawings describe example embodiments. The following detailed description references the drawings, wherein:

FIG. 1 is a block diagram illustrating one example of a computing system 100 to provide information about print service providers to create a print product.

FIG. 2 is a flow chart illustrating one example of a method to provide information about print service providers to create a print product.

FIG. 3 is a diagram illustrating one example of determining capabilities of print service providers.

FIG. 4 is a diagram illustrating one example of a user interface for displaying different print service providers to perform different production aspects of creating a custom print product.

FIG. 5A and FIG. 5B are diagrams illustrating examples of user interfaces for designing a print product where the user interfaces are based on the familiarity of the user with print products.

### DETAILED DESCRIPTION

It some cases, it may be difficult for print service providers (PSPs), which are often small businesses, to attract new clients and advertise new features. For example, print service providers may rely on existing relationships and trade shows for acquiring business. It may also be difficult for a potential customer to easily locate a print service provider to create a custom print product. For example, a designer may have a particular image to be printed on paper, tile, glass, or other substrates, and the designer may have specifications in addition to the custom image, such as a particular substrate thickness or a particular binding of multiple substrates.

In one implementation, a processor extracts information about the capabilities of a print service provider from an individual print service provider catalogue information uploaded to the system, such as a cloud based system that stores collective print capabilities information associated with multiple print service providers. For example, a print service provider may upload information including Job Definition Format (JDF) descriptions of the products they offer. The processor may analyze the Job Definition Format descriptions to determine the capabilities of the print service provider. A user interface may be provided to a user that allows a user to search for a custom product based on specifications. The processor may then match the user specifications to the capabilities of the print service providers to determine the print service providers capable of producing the custom print product. The system may be dynamic such that the match may be determined based on the current print capabilities included in a print capabilities database. A print service provider may upload a new catalogue or otherwise change their capabilities in the system. A user may search at a later time and receive a different set of print service providers with the print capabilities due to a change in a print service provider's capabilities.

The processor may determine a manner of displaying the subset of print service providers capable of producing the custom print product based on additional criteria related to the respective desirability of producing the product to each of the print service providers in the subset. As an example, a print service provider may rank products, types of specifications, user locations or other features based on the desirability of each, and the processor may analyze the information to determine, for example, an order to display the print service providers or an advertisement to display for one of the print service providers. The print service provider may rank products based on what is more profitable them, and the information may be updated to allow for a dynamic display system. A processor may determine a manner for displaying the print service provider information based on the rankings. For example, the processor may analyze the rankings from the individual print service providers to determine a manner of displaying the information that resolves conflicts between the individual rankings. The method may allow print service providers to better distinguish themselves, provide more tailored ads to a more targeted audience, and to capture a market they are more interested in capturing.

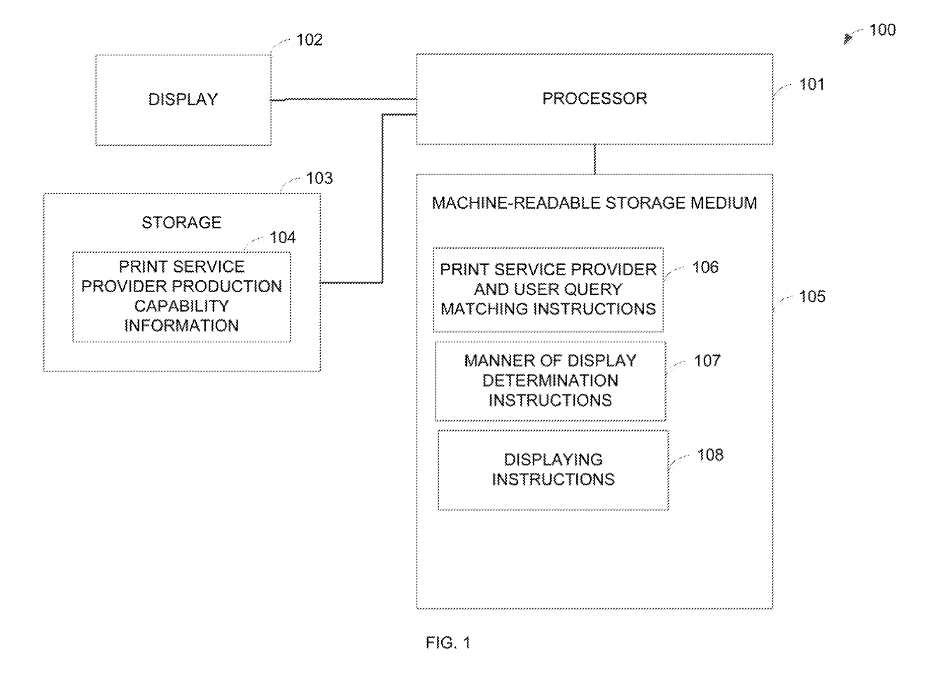

FIG. 1 is a block diagram illustrating one example of a computing system 100 to provide information about print service providers to create a print product. A user interface may be generated to allow a user to provide specifications for the print product order. A processor may determine print service providers capable of providing the custom print product and display them to a user.

The computing system 100 may include a processor 101, a display 102, a storage 103, and a machine-readable storage medium 105. The computing system 100 may be included in an apparatus, such as a laptop computer. The computing system 100 may involve a cloud implementation, such as where the processor 101 receives information from the storage 103 via a network and provides via a network a user interface to a display 102 associated with a user computer. In one implementation, the processor 101 is a web server providing content to a client computing device.

The display 102 may be a display for providing information to a user. A user interface may be generated by the processor 101 and caused to be displayed on the display 102. The display 102 may be associated with a user electronic device separate from the processor 101.

The storage 103 may be any suitable storage for storing information by the processor 101 that may be later retrieved. In some cases, the information is stored by a different processor and retrieved by the processor 101. The storage 103 may be directly accessible by the processor 101 or may be accessible via a network.

The storage 103 may include print service provider production capability information 104. The print service provider production capability information 104 may be stored as, for example, an Extensible Markup Language (XML) file or as relational database records. The print service provider production capability information 104 may include information about multiple print service providers and the types of production capabilities of each. The print service provider production capability information 104 may be related to final products and/or combinations of production steps. In some cases, the print service provider production capability information 104 lists individual capabilities of each entity such that they may be combined for the custom product specifications of the user.

In one implementation, the print service provider production capability information 104 is extracted from catalogue information related to the print service providers. For example, the processor 101 or a separate processor may analyze Job Definition Format intent information from products provided in a print service provider catalogue to determine the printing capabilities of a print service provider. The information may be extracted and stored in the storage 103 in a format allowing for a simpler search by the processor 101.

The processor 101 may be a central processing unit (CPU), a semiconductor-based microprocessor, or any other device suitable for retrieval and execution of instructions. As an alternative or in addition to fetching, decoding, and executing instructions, the processor 101 may include one or more integrated circuits (ICs) or other electronic circuits that comprise a plurality of electronic components for performing the functionality described below. The functionality described below may be performed by multiple processors.

The processor 101 may communicate with the machine-readable storage medium 105. The machine-readable storage medium 105 may be any suitable machine readable medium, such as an electronic, magnetic, optical, or other physical storage device that stores executable instructions or other data (e.g., a hard disk drive, random access memory, flash memory, etc.). The machine-readable storage medium 105 may be, for example, a computer readable non-transitory medium. The machine-readable storage medium 105 may include print service provider and user query matching instructions 106, manner of display determination instructions 107, and displaying instructions 108.

The print service provider and user query matching instructions 106 may include instructions to match a print service provider with a user query for a custom print product. For example, a user interface may be provided that allows a user to provide specifications related to the custom print product. The processor 101 may compare the specifications to the capabilities of the print service providers based on the stored print service provider production capability information 104, such as by using a database query language.

The manner of display determination instructions 107 may include instructions to determine a manner of displaying information about the matched print service providers based on criteria related to the desirability of producing the custom print product associated with the individual matched print service providers. For example, the print service providers may provide information about preferred types of orders, and a print service provider preferring to capture the particular type of order may be displayed larger, with an advertisement, or earlier in a list of matching print service providers.

The displaying instructions 108 may include instructions to display a user interface in the determined manner on the display 102 to be viewable by a user. In some implementations, the user interface allows a user to select one or more of the print service providers, and the user interface facilitates the sale of the custom print product by the selected print service provider.

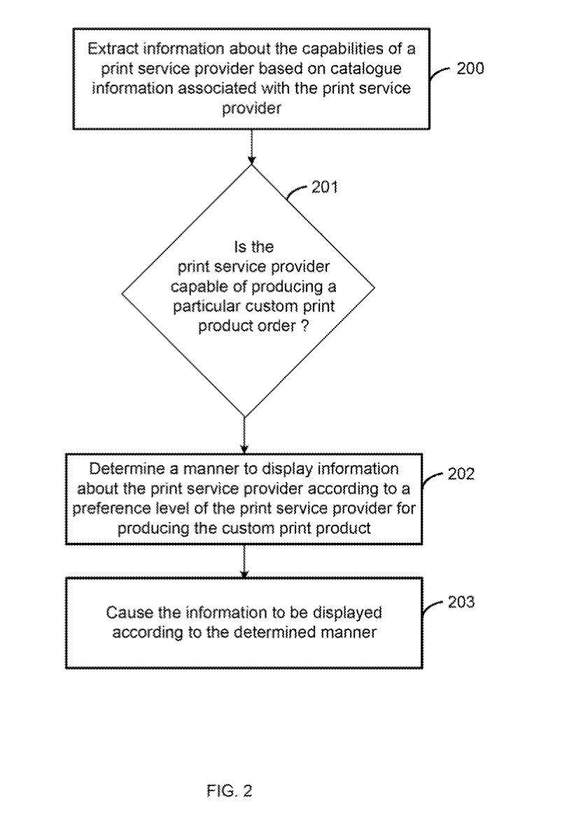

FIG. 2 is a flow chart illustrating one example of a method to provide information about print service providers to create a print product. For example, a processor may determine and store information about the capabilities of print service providers and match the stored capability information to a user request. The processor may then determine a manner to display the matching print service providers based on additional dynamic factors provided by the print service providers indicating their priority for providing the requested service. The method may be implemented, for example, by the processor 101 of FIG. 1.

Beginning at 200, a processor extracts information about the capabilities of a print service provider based on catalogue information associated with the print service provider. The print service provider may be any entity providing a service of creating print products. The print service provider may have a factory for printing different types of images on different substrates. Print service providers may have different capabilities, for example, due to factors such as the substrates that they keep in inventory or the equipment at the factory.

The catalogue information may be any suitable information related to the types of products offered by the print service provider. In one implementation, the processor generates a user interface allowing the print service provider to upload information about their capabilities, such as allowing the print service provider to upload a PDF or other file type. The processor may extract capabilities information from the uploaded information and store it in a database. In one implementation, the print service provider may view the uploaded list of capabilities and add, delete, or edit their offerings.

The processor may extract the information in any suitable manner. The catalogue information may include, for example, Job Definition Format information related to the products offered by the print service provider, and the processor may determine the capabilities based on Job Definition Format intent information associated with the products. The processor may save the combinations of specifications included in the catalogue. In one implementation, the processor extracts individual capabilities that may be paired in a different manner based on new specifications. The extracted capabilities information may be any suitable information related to the production of a print product. For example, the capabilities may be related to substrates, inks, and bindings of print products.

The processor may extract the catalogue information from multiple print service providers. In one implementation, the user interface allows a print service provider to select whether to input capabilities directly or whether to upload existing product information. The processor may store the information related to multiple print service providers in a database that may then be searched.

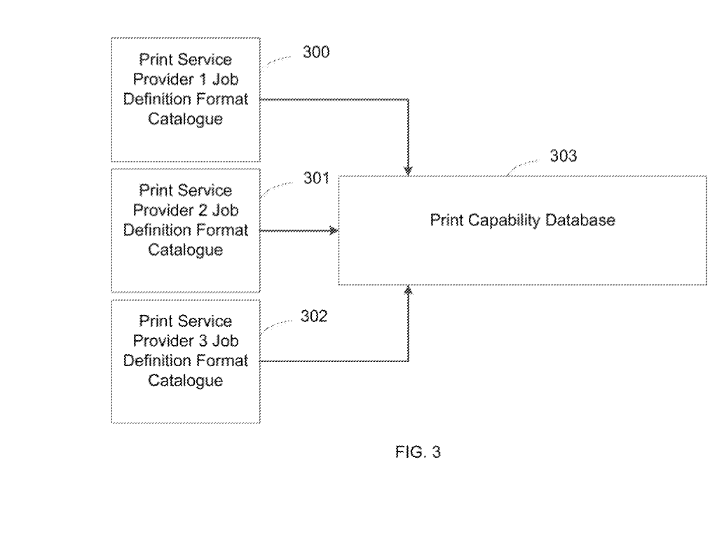

FIG. 3 is a diagram illustrating one example of determining capabilities of print service providers. FIG. 3 shows three catalogues including Job Definition Format information being uploaded to be stored in the print capability database 303. For example, print service provider 1 Job Definition Format catalogue 300, print service provider 2 Job Definition Format catalogue 301, and print service provider 3 Job Definition Format catalogue 302 may be processed and added to the print capability database 303. In one implementation, a processor analyzes Job Definition Format intent information from each of the catalogues and stores information related to capabilities determined from the Job Definition Format intent information. The information may be extracted as individual items, or the complete items may be stored, such as where a print service provider is assumed to make products in the combination of specifications provided in the catalogue. Other standardized job description formats may be used in a similar manner to Job Definition Format information.

Allowing a Job Definition Format catalogue to be uploaded may allow a print service provider to provide information on its capabilities without using an additional interface to specify their capabilities. In one implementation, the catalogue is uploaded, and a print service provider administrator is then shown a user interface with the information extracted from the catalogue such that the print service provider administrator may edit, add, or delete capabilities.

In one implementation, qualitative factors are also coupled with the capabilities information in the print capability database 303. For example, information about quality, reliability, or sustainability may be associated with the different products and/or specification types. The information may be used to show the particular strengths of the particular print service providers. The information may be determined, for example, based on customer feedback or ratings.

Referring back to FIG. 2 and continuing to 201, the processor determines if the print service provider is capable of producing a particular custom print product order based on the extracted information. The processor may receive a user request to produce a custom print product. For example, the processor or another processor may cause a user interface to be displayed that allows a user to select product. As an example, a user interface may allow a user to select the binding, paper appearance, paper grade, dimensions, and paper color of a custom print product involving an image to be printed on paper. The user interface may allow a user to upload a design to be printed on the print product. For example, the print product may be a printed design on any suitable substrate, such as a book, tile, or other print product. A processor may compare the specifications of the print product to the capabilities of multiple Print Service Providers to determine those capable of producing the custom print product.

The processor may compare the specifications of the custom print product to the extracted information related to capabilities of the print service providers. The processor may determine a subset of the print service providers capable of producing the custom print product. For example, the processor may compare the specifications to the stored information related to the capabilities of the print service providers. The processor may search for items such a substrate types, equipment used, or type of ink. In one implementation, a user may search on factors in addition to the print product specifications. For example, the user may search for print service providers using a more environmentally sustainable product or business method, with a higher quality reputation, or closer to the buyer.

Continuing to 202, if the print service provider is determined to be capable of fulfilling the print product order, the processor determines a manner to display information about the print service provider according to a preference level of the print service provider for producing the custom print product. The processor may determine a manner to display information related to the subset of print service providers determined to be capable of producing the print product. The processor may access stored information related to a print service provider's preference for providing the service of creating the custom product. For example, the print service provider may provide a priority associated with different products in their catalogue, such as by marking some as high priority and some as lower priority. In one implementation, determine the capability of a print service provider and the preference level for providing the capability may be performed by accessing a single database. The information may be stored in any suitable manner, such as in a relational database or in an Extensible Markup Language (XML) file.

The print service provider may provide priority rankings to particular specifications, such as user location, equipment used, or the due date of the project independent or in addition to ranking the particular catalogue offerings. In one implementation, the priority is tied to an amount the print service provider is willing to pay for a higher ranking in the list or for an advertisement.

The processor may compare the different priorities of the print service providers to determine how to display the information. For example, preference may be given to print service providers ranking a type of order as a higher priority. The processor may determine a collective ranking or ordering of the print service providers with the print capabilities based on the priorities provided by the print service providers. The processor may use any suitable method to resolve conflicts between the individual rankings, such as by providing the preferred ranking to as many print service providers as possible, preferring particular print service providers or types of print service providers where conflicts arise, and/or providing a ranking such that as many print service providers as possible are given a ranking as close as possible to their preferred ranking. In some cases, the processor may determine a display manner in which there are no conflicts, such as where two print service providers rank a type of query as high priority and the processor displays an advertisement for each of the two print service providers.

A user interface may allow a print service provider to provide the preference information, and the information may be stored to be later accessed by the processor to be compared to the custom print order. The print service provider may periodically update the preference information as conditions change. In one implementation, the processor communicates via a network with an electronic device associated with the print service provider such that the preference information may be automatically updated at a particular interval.

The print service providers may account for various factors in determining their degree of preference for producing particular types of products. The degree of preference may be a set preference or a criterion for comparing the custom order to a threshold. In some cases, the print service provider may provide information about products that it is capable of producing along with criteria as to other factors of when it will produce them, such as a product it produces only when the volume is over a threshold. In some implementations, the print service provider may provide information about a priority, such as that the entity will produce the item, but would like to advertise to produce the item when other factors are present.

The preference level may be related to any suitable criteria. For example, the print service provider may provide a priority to different types of custom products based on a profitability of the customer products. The print service provider may upload information about profitability or profitability levels with different specifications, and the processor may determine profitability information associated with the requested print product. The processor may then determine whether the profitability falls above a threshold provided by the print service provider.

In one implementation, the processor determines equipment used for a custom order and checks the availability of the equipment for the entities. For example, the print service provider may associate equipment with each type of custom order and provide an availability level for the equipment. The availability level may be periodically updated such that the print service provider can update the availability without specifically updating information about the individual priorities. The print service provider may prioritize in a manner that leverages existing machines and particular those not under-utilized.

In one implementation, the preference level criteria may involve a time frame or seasonality. For example, a print service provider may provide a low priority for orders in the winter, a medium priority for summer orders, and a high priority for orders due at other times. In some cases, the print service provider may provide a time frame criteria on the amount of time to finish the project. For example, at busier times the print service provider may not want rush orders.

The preference level criteria may involve a volume of work, such as a volume above or below a threshold. A print service may prefer a higher volume of work. A print service provider may prefer an amount of work that may be handled by one worker or machine that still greatly utilizes that worker or machine, such as where the print service provider prefers a volume greater than a first threshold but less than a second threshold.

In one implementation, a print service provider may prioritize locations associated with orders. For example, a print service provider may want to perform orders to clients closer to the print service provider factory, or the print service provider may prioritize reaching clients farther away in new markets.

In one implementation, the print service provider provides information about inventory levels and a threshold. For example, the print service provider may indicate that orders of a certain type are higher priority when the print service provider's inventory of the components are above a threshold. For example, a print service provider may have large quantities of stocks that uses for their existing large accounts, and the new jobs may be batched with the existing ones running on the same stock. The processor may compare the inventory information to the materials used for the custom order.

In one implementation, the preference level is based on a technology associated with the custom order. For example, the print service provider may want to promote itself as a leader in a new technology and may prioritize orders that involve the use of the particular printing technology.

The degrees of preference may be based on multiple combined factors or product query attributes. For example, a print service provider may have a type of equipment that tends to be less utilized in the winter, and the print service provider may want to prioritize orders involving that equipment during that slower period.

The manner of displaying information may include prioritizing the entities capable of producing the product, such as displaying a subset of the matching entities or displaying them in an order showing higher priority entities first. In one implementation, the manner of displaying includes displaying an advertisement related to an entity. The processor may determine which entities to display advertisements for. In some cases, the processor may further determine from a set of advertisements which to display for a particular entity based on the user query. For example, a different type of advertisement may be displayed based on user location or the type of substrate used in the product. The processor may categorize the type of custom product and compare the type to stored information pairing an advertisement with a type of custom product.

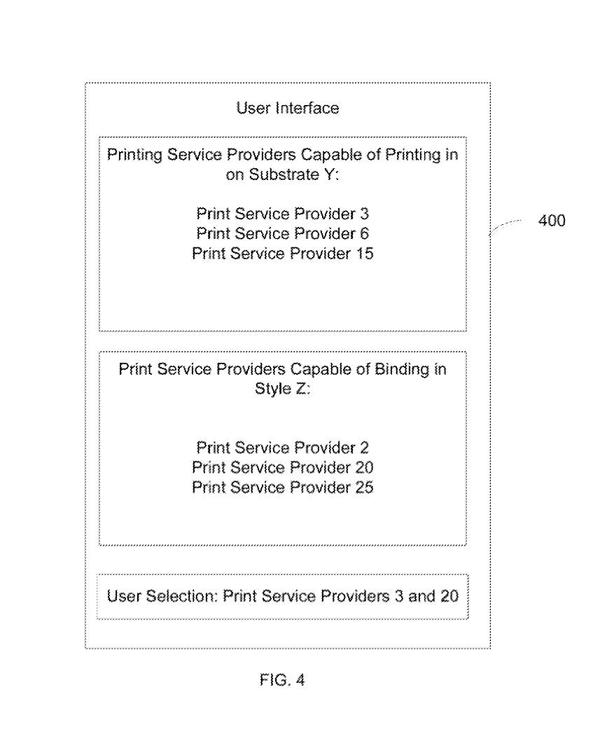

In one implementation, the processor determines a manner to display different groups of print service providers for different steps of producing the custom product. FIG. 4 is a diagram illustrating one example of a user interface for displaying different print service providers to perform different production aspects of creating a custom print product. The user interface 400 shows a first set of print service providers capable of printing on substrate Y and a second set of print service providers capable of binding a print product in style Z. The user interface 400 shows a user selection of print service provider 3 to print on the substrate and print service provider 20 to bind the printed items.

In one implementation, a processor determines print service providers in three categories of media/substrate characteristics, folding characteristics, and combining characteristics, such as binding, collating, or knitting. The custom print product and the associated available print service providers may be represented in a tree representation that allows a user to select any combination of a print product, such as a first page folded and the remaining knitted. As a result, a custom product may not be limited to the capabilities of a single print service provider. Production of the print product may be split between multiple print service providers due to additional factors, such as the volume of the order or the spare capacity or inventory of different print service providers. For example, a first print service provider may produce half of the booklets of an order, and a second print service provider may produce the other half of the booklets of an order. A processor may determine how to display the available print service providers for each part of the process, such as the order or advertisements.

Referring back to FIG. 2 and proceeding to 203, a processor causes the information to be displayed according the determined manner. In one implementation, the processor compares the relative priority given to the order by the print service providers capable of producing the order. The processor may select an order for displaying the print service providers, select a size or position to display information about a print service provider, or determine whether to display an advertisement for the different service providers. In one implementation, if the processor determines to display and advertisement for a particular print service provider, the processor then determines the content of the advertisement based on the specifications for the print product. If a user changes the specifications, the display may be updated. In one implementation the user interface facilitates the sale of the order between the user and the print service provider after allowing the user to select one of the print service providers to fulfill the order.

In one implementation, the user interface is displayed according to a user familiarity with print products. The user interface for providing the print product specification and/or the user interface for displaying matches may be tailored to a familiarity level of the user. For example, the number of specification options, the types of advertisement, or the descriptive language used may be tailored to the type of user.

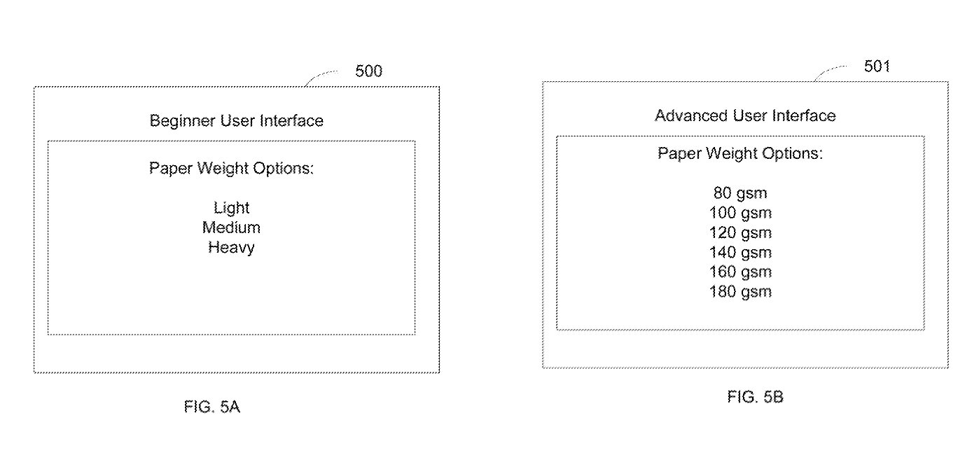

FIG. 5A and FIG. 5B are diagrams illustrating examples of user interfaces for designing a print product where the user interfaces are based on the familiarity of the user with print products. For example, user interface 500 if FIG. 5A describes paper weight options to a user in terms of qualitative terms, and user interface 501 of FIG. 5B describes paper weight options to a user in numeric terms. There may be any number of different user interfaces. In one implementation, a beginner, intermediate, or advanced level user interface may be provided. The different levels may be tailored to the understanding of people with different familiarities with print products. For example, someone working in public relations may have an intermediate knowledge of print products, an individual consumer may have a beginning knowledge of print products, and a designer may have an advanced knowledge of print products.

The processor may determine the familiarity level of the user, such as from information from the user about his familiarity level, from answers to questions about the type of product from the user, from information about a position of the user, and/or from information about the use of the custom print product. The processor may then select the appropriate interface based on the determined category.

In one implementation, the user interface level for providing the specifications for the print product may be used for displaying the print service providers. The print service providers may be displayed differently and with different information according to the level of the user. In one implementation, advertisements with different content are shown for the same print service provider depending on the print product knowledge level of the user. In some cases, a print service provider may mark users of a particular knowledge area as a higher preference level, such as where the print service provider would like to be ranked higher or with more advertisements to capture a new type of user market.

Providing an automated system for matching potential buyers and print service providers may allow for print service providers to reach otherwise difficult markets. Displaying information about print service providers according to their degree of preference to capture particular markets and orders may greatly facilitate that ability of print service providers to reach new profitable customers.

1. A computing system, comprising:
a storage to store information about the capabilities of multiple print service providers, wherein the information about the capabilities is extracted from information related to the products of the print service providers; and
a processor to:
match a subset of the print service providers with a user query for a service to produce a custom print product based on a comparison of the user query to the stored information;
determine a manner of displaying information about the matched print service providers based on criteria related to the desirability of producing the custom print product associated with at least one of the print service providers; and
cause the information to be displayed in the determined manner.

2. The computing system of claim 1, wherein determining a manner of displaying information comprises selecting an advertisement for the least one of the print service providers based on characteristics of the user query.

3. The computing system of claim 1, wherein extracting the information comprises extracting the information from Job Description Format intent information related to the products of the print service providers.

4. The computing system of claim 1, wherein the criteria associated with the at least one print service provider comprises at least one of:
a profitability associated with user query;
equipment utilization associated with the print service provider;
a volume associated with the user query;
a time frame associated with the user query;
a location associated with the user query;
a technology involved in creating the custom print product of the user query;
an inventory level associated with the print service provider; and
a spare capacity level associated with the print service provider.

5. The computing system of claim 1, further comprising causing a user interface to be displayed to receive the user query wherein the user interface is associated with a familiarity level of a user with the custom print product.

6. The computing system of claim 1, wherein the processor causes the information to be displayed in a manner that associates a different group of print service providers with different steps of the production of the custom print product.

7. A method, comprising:
extracting information about the capabilities of a print service provider based on catalogue information associated with the print service provider;
determining if the print service provider is capable of producing a particular custom print product order based on the extracted information;
if determined the print service provider is capable of producing the custom print product, determine a manner to display information about the print service provider according to a preference level of the print service provider for producing the custom print product; and
causing the information to be displayed according to the determined manner.

8. The method of claim 7, wherein the preference level is based on at least one of:
a profitability associated with the custom print product order;
an equipment utilization level associated with the print service provider;
a volume of the custom print product order;
a time frame associated with the custom print product order;
a technology involved in creating the custom print product order;
a location associated with the shipment of the print product order;
an inventory level associated with the print service provider; and
a spare capacity level associated with the print service provider.

9. The method of claim 7, further comprising receiving a request for the custom print product order from a user interface displayed according to a familiarity level of a user with the type of custom print product.

10. The method of claim 7, wherein determining a manner to display the information comprises at least one of:
determining to display an advertisement for the print service provider;
determining a position on the user interface to display information about the print service provider;
determining an amount of the user interface space to allocate to information about the print service provider; and
determining to display information about the print service provider in a particular order relative to other print service providers capable of producing the custom print product.

11. A machine-readable non-transitory storage medium comprising instructions executable by a processor to:
extract information about the capability of print service providers from Job Definition Format information from each of the print service providers, respectively;
determine a subset of the print service providers capable of fulfilling a custom print product order based on the extracted information;
provide a user interface including information about print service providers capable of fulfilling the custom print product order,
wherein the user interface displays the information based on preferences of the print service providers for fulfilling the particular type of custom print product order.

12. The machine-readable non-transitory storage medium of claim 11, further comprising instructions to access stored information related to the preferences of the print service providers.

13. The machine-readable non-transitory storage medium of claim 11, further comprising instructions to determine different subsets of the print service providers associated with different aspects of producing the custom print product.

14. The machine-readable non-transitory storage medium of claim 11, wherein the different aspects of producing the custom print product comprise substrate characteristics, folding characteristics, and combining characteristics.

15. The machine-readable non-transitory storage medium of claim 11, further comprising instructions to:
determine a familiarity level of a user with print products; and
provide the user interface according to the determined familiarity level.
